(19) United States
(12) Patent Application Publication
(10) Pub. No.: US 2012/0202039 A1
(43) Pub. Date: Aug. 9, 2012

(54) IN SITU POLYMERIZATION OF CONDUCTING POLY(3,4-ETHYLENEDIOXYTHIOPHENE)

(75) Inventors: Michael S. Freund, Winnipeg (CA); Nick Svenda, Winnipeg (CA); Bhavana A. Deore, Ottawa (CA)

(73) Assignee: UNIVERSITY OF MANITOBA, Winnipeg, MB (CA)

(21) Appl. No.: 13/383,397

(22) PCT Filed: Jul. 9, 2010
(86) PCT No.: PCT/CA2010/001069

§ 371 Date: Apr. 24, 2012

Related U.S. Application Data
(60) Provisional application No. 61/224,630, filed on Jul. 10, 2009.

(51) Int. Cl. C08G 75/06; H01B 1/12

(52) U.S. Cl. 428/220; 526/256; 526/172; 252/500; 252/519.21

(57) ABSTRACT

Conducting poly(3,4-ethylenedioxythiophene) films are prepared upon solvent removal using an easily processable metastable solution of monomer and oxidant. This method allows the casting and spin-coating of films on conducting as well as insulating substrates with conductivities as well as optical and redox properties similar to those reported for chemically (vapor phase) and electrochemically synthesized thin films. Morphological characterization of spin coated poly(3,4-ethylenedioxythiophene) films suggest that they are smooth, uniform and free of pinholes on the micron scale. These films show conductivities in the range of 0.03 to 5 S/cm.

### CROSS REFERENCE TO RELATED APPLICATIONS

This application claims the benefit of U.S. Provisional Patent Application Ser. No. 61/224,630 entitled “IN SITU POLYMERIZATION OF CONDUCTING POLY(3,4-ETHYLENEDIOXYTHIOPHENE)” filed on Jul. 10, 2009, which is incorporated herein by reference in its entirety.

### FIELD

In one aspect, the invention relates to a method of preparing poly(3,4-ethylenedioxythiophene) (PEDOT) comprising mixing 3,4-ethylenedioxythiophene (EDOT) and an oxidant in a solvent, and removing the solvent to produce PEDOT. In another aspect, the invention relates to PEDOT produced by the method.

### BACKGROUND

The electrochemical synthesis of poly(3,4-ethylenedioxythiophene) (PEDOT), a promising organic conducting polymer, was reported by Bayer AG research laboratories in Germany (see, for example, Jonas, F. et al. Eur. Patent No. 3:39 340 (1988); Jonas, F. and Schrader, L. Synth. Met. 1991, 41, 831; Heywang, G. and Jonas, F. Adv. Mater. 1992, 4, 116). PEDOT has been reported to exhibit a number of desirable properties in the oxidized state, including high conductivity, good stability, high thin-film transparency and reduced band gap (Ca. 1.6-1.7 eV). Accordingly, PEDOT has been used in a number of applications, including electrochromic displays, antistatic coatings on different materials, solid electrolyte capacitors, organic light-emitting diodes (OLEOS), solid state ion sensors, biosensors, and solar and fuel cells (see, for example, Groenendaal, L., Jonas, F., Freitag, D., Pielartzik, H., Reynolds, J. Adv. Mater. 2000, 12, 481; Groenendaal, L., Zotti, G., Aubert, P., Waybright, S. M., Reynolds, J. Adv. Mater. 2003, 15, 855 and references therein).

In PEDOT, the 3- and 4-positions of the thiophene ring are blocked by oxygen, minimizing unwanted polymerization at these two β-carbon sites. Moreover, the oxygen acts as an electron-donating group, increasing the electron density of the thiophene ring. Therefore, the conjugated polythiophene ring can easily be positively charged in the presence of anionic dopants (see, for example, Im, S. G. and Gleason, K. K. Macromolecules 2007, 40, 6552). However, it has been reported that PEDOT is highly insoluble in almost every solvent due to the rigid nature of the conjugated backbone (see, for example, Jonas, F. et al. Eur. Patent No. 339 340 (1988); Jonas, F. and Schrader, L. Synth. Met. 1991, 41, 831; Heywang, G. and Jonas, F. Adv. Mater. 1992, 4, 116).

It has been reported that PEDOT can be polymerized by chemical and electrochemical methods (see, for example, Groenendaal, L., Jonas, F., Freitag, I., Pielartzik, H., Reynolds, J. Adv. Mater. 2000, 12, 481; Groenendaal, L., Zotti, G., Aubert, P., Waybright, S. M., Reynolds, J. Adv. Mater. 2003, 15, 855 and references therein). The chemically oxidized PEDOT results in a black, insoluble, infusible and intractable material, whereas electrochemical polymerization can only be obtained on conducting substrates.

An alternative approach has been reported to obtain a processable water emulsion of PEDOT with the use of a polyelectrolyte dopant such as poly(styrenesulfonic acid) (PSS) by scientists at Bayer AG (Baytron™ P) (see, for example, Jonas, F. and Morrison, J. T. Synth. Met. 1997, 85, 1397; Jonas, F. and Heywang, G. Electrochim. Acta 1994, 39, 1345). It has been reported that the polymer has excellent electro-optical properties and conductivity in the range of 0.1 to ˜10 S/cm. However, drawbacks of PEDOT/PSS have been reported, such as low water resistance, low electrochemical stability, and low mechanical strength of printed films (see, for example, Groenendaal, L., Jonas, F., Freitag, D., Pielartzik, H., Reynolds, J. Adv. Mater. 2000, 12, 481). In addition, to achieve a uniform polymer film, a complicated additional hydrophilic substrate treatment, such as oxygen plasma treatment or UV-ozone treatment, is needed (see, for example, Kobayashi, H., Kanbe, S., Seki, S., Kiguchi, H., Kimura, M., Yudasaka, I., Miyashita, S., Shimoda, T., Towns, C. R., Burroughes, J. H., Friend, R. H. Synth. Met. 2000, 111, 125).

Recently, thin films of PEDOT have been achieved by oxidative chemical vapor deposition using oxidant Fe(III)Cl₃ (see, for example, Lock, J. P., Im, S. G., Gleason, K. K. Macromolecules 2006, 39, 5326; Im, S. G. and Gleason, K. K. Macromolecules 2007, 40, 6552) and iron toluenesulfonate (see, for example, Winther-Jensen, B. and West, K. Macromolecules 2004, 37, 4538) with conductivities in the range of 105 to 1000 S/cm by varying substrate temperature. The configuration of the vacuum reactors is required for oxidative chemical vapor deposition step growth polymerization.

Polymerization of pyrrole using phosphomolybdic acid (PMA) as oxidant to produce well-behaved polypyrrole films has been reported (see, for example, Freund, M. S., Karp, C., Lewis, N. S. Current Separations 1994, 13, 66; Freund, M. S., Karp, C., Lewis, N. S. Inorg. Chim. Acta 1995, 240, 447; Freund, M. S. and Lewis, N. S. Proc. Natl. Acad. Sci. U.S.A. 1995, 92, 2652). Polymerization of polythiophene using bithiophene or terthiophene monomer and PMA as oxidant has been reported (see, for example, Freund, M et al. WO 2006/125325; Bravo-Grimaldo, E., Hachey, S., Cameron, C. G., Freund, M. S. Macromolecules 2007, 40, 7166).

Approaches for preparing PEDOT in a processable form are desired. Approaches or preparing PEDOT with advantageous properties, for example, good water resistance, good electrochemical stability and good mechanical strength, are desired.

### SUMMARY

In one aspect, there is provided a method of preparing poly(3,4-ethylenedioxythiophene) (PEDOT), the method comprising mixing 3,4-ethylenedioxythiophene (EDOT) and an oxidant in a solvent, and removing the solvent to produce PEDOT.

In one embodiment, the solvent may be removed by evaporation.

In a further embodiment, the oxidant may be phosphomolybdic acid.

In another embodiment, the solvent may be acetonitrile.

In a further embodiment, PEDOT may be formed by spin-coating.

In another embodiment, the method may further comprise doping the PEDOT with an oxidizing agent.

In a further embodiment, the oxidizing agent for doping the PEDOT may be iron (III) paratoluenesulfonate.

In another aspect, there is provided poly(3,4-ethylenedioxythiophene) (PEDOT) produced by a method comprising mixing 3,4-ethylenedioxythiophene (EDOT) and an oxidant in a solvent, and removing the solvent to produce PEDOT.

In one embodiment, PEDOT may be doped with an oxidizing agent.

In another embodiment, the oxidizing agent may be iron (III) paratoluenesulfonate.

In a further embodiment, PEDOT produced may be smooth and pinhole-free.

In another embodiment, PEDOT produced may have a conductivity in a range of 0.03 to 5 S/cm.

In still another embodiment, PEDOT produced may be a film having a film thickness of 50 nm up to and including 5 microns.

### BRIEF DESCRIPTION OF THE DRAWINGS

Embodiments will be discussed with reference to the following Figures:

FIG. 1. Evolution of spectra at 800 nm as a function of time during polymerization in 0.02M EDOT in acetonitrile in the presence of 0.03 M phosphomolybdic acid.

FIG. 2. Proposed mechanism of polymerization of EDOT as the monomer.

FIG. 3. Optical images of spin-coated PEDOT/PMA films using 0.2 M EDOT and 0.3 M phosphomolybdic acid in acetonitrile.

FIG. 4. Scanning electron microscopy (SEM) images of PEDOT/PMA thin film at A) low and B) high magnification prepared using 0.2 M EDOT and 0.3 M phosphomolybdic acid in acetonitrile.

FIG. 5. Cyclic voltammetric (CV) measurements of PEDOT/PMA on glassy carbon (GC) electrode in A) 0.5 M H₂SO₄, B) 0.1 M TBAPF₆ in acetonitrile and C) 0.1 M LiClO₄ in propylene carbonate at a scan rate of 50 mV/s. Films prepared using 0.2 M EDOT and 0.3 M phosphomolybdic acid in acetonitrile.

FIG. 6. Spectroelectrochemistry of chemically grown PEDOT/PMA film on indium-doped tin oxide (ITO) in 0.1 M TBAPF₆/acetonitrile. Films prepared using 0.2 M EDOT and 0.3 M phosphomolybdic acid in acetonitrile.

### DETAILED DESCRIPTION

Embodiments relate to a method of preparing PEDOT using a metastable mixture of monomer and oxidant in solvent followed by polymerization by solvent removal.

In an embodiment, a metastable mixture of monomer and oxidant in solvent may be formed by, for example, and without limitation, selecting a suitable monomer, oxidant, solvent, monomer concentration, oxidant concentration and/or solvent removal rate. In an embodiment, for example, and without limitation, selection of a suitable monomer or oxidant may involve selection of an oxidant whose formal potential is close to, but lower than, the oxidation potential of the monomer. In an embodiment, for example, and without limitation, selection of a suitable monomer or oxidant ay involve ensuring that the concentration of oxidized monomer in the mixture is relatively low, thereby resulting in a relatively slow polymerization rate.

The polymer is not particularly limited, and suitable polymers would be understood to and can be determined by those of ordinary skill in the art. In an embodiment, the polymer may be, for example, and without limitation, poly(3,4-ethylenedioxythiophene).

The monomer is not particularly limited, and suitable monomers would be understood to and can be determined by those of ordinary skill in the art. In an embodiment, the monomer may be, for example, and without limitation, 3,4-ethylenedioxythiophene.

The oxidant is not particularly limited, and suitable oxidants would be understood to and can be determined by those of ordinary skill in the art. In an embodiment, the oxidant may have, for example, and without limitation, an oxidation potential that is between the formal potential of the monomer and the oxidation potential of the polymer once formed. In an embodiment, the oxidant may have, for example, and without limitation, an oxidation potential that is close to but lower than the oxidation potential of the monomer. In an embodiment, the oxidant may have, for example, and without limitation, an oxidation potential that is lower than the oxidation potential of EDOT. In an embodiment, the oxidant may have, for example, and without limitation, an oxidation potential that is between the formal potential of EDOT and the oxidation potential of PEDOT. In an embodiment, the oxidant may have, for example, and without limitation, an oxidation potential that is lower than 0.95 V (see, for example, Snook, G. A., Peng, C., Fray, D. J., Chen, G. Z. Electrochemistry Communications 2006, 9, 83). In an embodiment, the oxidant may have, for example, and without limitation, an oxidation potential that is close to but lower than 0.95 V. In an embodiment, the oxidant may have, for example, and without limitation, an oxidation potential of 0.36 V. In an embodiment, the oxidant may be, for example, and without limitation, phosphomolybdic acid.

The solvent is not particularly limited, and suitable solvents would be understood to and can be determined by those of ordinary skill in the art. In an embodiment, the solvent may be, for example, and without limitation, a polar aprotic solvent. In an embodiment, the solvent may be, for example, and without limitation, acetonitrile or tetrahydrofuran (THF).

The final concentration of the monomer in the mixture of monomer, oxidant and solvent is not particularly limited, and suitable concentrations of the monomer would be understood to and can be determined by those of ordinary skill in the art. In an embodiment, the concentration of the monomer may be, for example, and without limitation, about 0.02 M or greater, about 0.05 M or greater, about 0.1 M or greater, about 0.15 M or greater, about 0.2 M or greater, about 0.3 M or greater, about 0.4 M or greater, about 0.5 M or greater, from about 0.02 M to about 0.5 M, from about 0.1 M to about 0.5 M, from about 0.1 M to about 0.4 M, and including any specific value within these ranges, for example, and without limitation, about 0.1 M, about 0.15 M, about 0.2 M, about 0.3 M, and about 0.4 M.

The final concentration of the oxidant in the mixture of monomer, oxidant and solvent is not particularly limited, and suitable concentrations of the oxidant would be understood to and can be determined by those of ordinary skill in the art. In an embodiment, the concentration of the oxidant may be, for example, and without limitation, about 0.03 M or greater, about 0.05 M or greater, about 0.1 M or greater, about 0.2 M or greater, about 0.3 M or greater, about 0.4 M or greater, from about 0.1 M to about 0.3 M, and including any specific value within these ranges, for example, and without limitation, about 0.1 M, about 0.2 M and about 0.3 M.

The ratio of monomer to oxidant (M/M) in the mixture of monomer, oxidant and solvent is not particularly limited and suitable ratios would be understood to and can be determined by those of ordinary skill in the art. In an embodiment, the ratio of monomer to oxidant may be, for example, and without limitation, from about 2:3 to about 4:1, and including any specific value within this range, for example, and without limitation, about 2:3, about 1:1, about 4:3, about 1.5:1, about 2:1, about 3:1 and about 4:1.

In an embodiment, the method may comprise, for example, and without limitation, mixing, in any order, the monomer and the oxidant in a solvent. In an embodiment, for example, and without limitation, the method may comprise: in any order, separately mixing the monomer in a solvent and separately mixing the oxidant in a solvent; and then mixing together the monomer in the solvent and the oxidant in the solvent.

In an embodiment, the method may further comprise, for example, and without limitation, depositing or applying the mixture of the monomer and the oxidant in the solvent onto a substrate. In an embodiment, the method may further comprise, for example, and without limitation, spin-coating the mixture of the monomer and the oxidant in the solvent onto a substrate. In an embodiment, for example, and without limitation, the mixture of the monomer and the oxidant in the solvent may be spin-coated onto the substrate at 2000 rpm for 10 s. In an embodiment, the method may further comprise, for example, and without limitation, casting the mixture of the monomer and the oxidant in the solvent onto a substrate. In an embodiment, the method may further comprise, for example, and without limitation, painting the mixture of the monomer and the oxidant in the solvent onto a substrate. In an embodiment, the mixture of the monomer and the oxidant in the solvent may be, for example, and without limitation, spin-coated, casted or painted onto the substrate before removing the solvent.

The substrate is not particularly limited, and suitable substrates would be understood to and can be determined by those of ordinary skill in the art. In an embodiment, the substrate may be, for example, and without limitation, a conducting or non-conducting substrate. In an embodiment, the substrate may be, for example, and without limitation, glass, indium-doped tin oxide glass, or a polymer.

In an embodiment, the method may further comprise, for example, and without limitation, annealing the polymer. In an embodiment, the polymer may be, for example, and without limitation, annealed in a solvent-saturated environment.

In an embodiment, the method may further comprise, for example, and without limitation, removing the solvent. In an embodiment, the solvent may be, for example, and without limitation, removed by evaporation. In an embodiment, the solvent may be, for example, and without limitation, removed by sublimation.

In an embodiment, the method may further comprise, for example, and without limitation, doping the polymer with an oxidizing agent. In an embodiment, the oxidizing agent may be, for example, and without limitation, iron toluenesulfonate or phosphotungstic acid (PTA).

Embodiments relate to the polymer prepared according to the method. In an embodiment, the polymer prepared according to the method may be, for example, and without limitation, PEDOT.

In an embodiment, the polymer may have, for example, and without limitation, a high conductivity. In an embodiment, the polymer may have, for example, and without limitation, a conductivity of about 0.03 to 5 S/cm, and including any specific value within the range.

In an embodiment, the polymer may be, for example, and without limitation, pinhole free. In an embodiment, the polymer may be, for example, and without limitation, pinhole free at the macroscopic or microscopic level.

In an embodiment, polymer may have, for example, and without limitation, good adhesion to a substrate.

In an embodiment, the polymer may be, for example, without limitation, stable over a range of pH values. In an embodiment, the polymer may be, for example, and without limitation, stable over a range of pH values when on a polymer substrate.

In an embodiment, the polymer may be, for example, and without limitation, a film.

In an embodiment, the film may have, for example, and without limitation, a substantially uniform thickness. In an embodiment, the film may have, for example, and without limitation, a thickness that is substantially uniform at the macroscopic or microscopic level. In an embodiment, the polymer may have, for example, and without limitation, a thickness of about 10 nm up to and including several micrometers. In an embodiment, the polymer may have, for example, and without limitation, a thickness of about 10 nm up to and including 5 micrometers, of about 50 nm up to and including 5 micrometers, and including any specific value within these ranges.

### EXAMPLES

Material and Chemicals. Phosphomolybdic acid hydrate (PMA, H₃—PMo₁₂O₄₀), 3,4-ethylenedioxythiophene (EDOT), acetonitrile (HPLC grade), propylene carbonate, lithium perchlorate, and tetrabutylammonium hexafluorophosphate (TBAPF₆) were purchased from Aldrich and used without any further purification. Indium-doped tin oxide (ITO, 6±2 Ω/square) glass slides were purchased from Delta Technologies, Limited. Prewashed glass slides were purchased from Fisher Scientific. Bulk distilled water was filtered then ion exchanged to yield 18.2 MΩ·cm quality water using Milli-Q-Academic™ A10 (Millipore Corporation).

Substrate Cleaning. Prewashed glass slides were cleaned by soaking in acetone for 10 minutes, rinsing in isopropanol and drying with an ionizing air gun (IonGun™, Terra Universal, Inc.). ITO glass slides were cleaned by washing with a light detergent, sonicating in deionized water for 30 minutes, soaking in acetone for 10 minutes, rinsing in isopropanol and drying with an ionizing air gun. Glassy carbon (GC) electrodes were cleaned by polishing with 0.05 μm Alumina (ALPHA MICROPOLISH™ II BUEHLER), rinsing in deionized water, soaking in methanol for 10 minutes and drying with an ionizing air gun.

Synthesis. PEDOT/PMA composite films were prepared by mixing equal volumes of EDOT and PMA (1:1.5 concentration ratio) in acetonitrile. The concentration of EDOT and PMA was 0.2 M and 0.3 M, respectively, in the final mixture. In order to optimize the film conductivity and properties, the concentration of PMA was varied while the starting concentration of EDOT was held at 0.2 M. The chemically synthesized films were prepared by spin-coating the mixture onto either plain glass substrates (nonconducting) or ITO glass slides at 2000 rpm for 10 s. It was observed that annealing the films in a solvent-saturated environment overnight significantly improved the conductivity of the films which is discussed below. All samples were allowed to dry in air for four hours prior to a final rinse in acetonitrile to remove excess PMA and unreacted EDOT. The samples were left to dry in a vacuum desiccator before characterization. The resulting films were transmissive blue and in the conductive oxidized state as illustrated by four-point probe measurements.

To enhance the conductivity of the PEDOT/PMA films, the PEDOT/PMA films were redoped with an oxidizing agent. PEDOT/PMA was immersed in a 0.1 g/mL solution of the respective oxidant in acetonitrile for 4 hours.

Characterization.

UV-Vis Spectroscopy. The chemical polymerization of EDOT with phosphomolybdic acid as oxidant in acetonitrile was studied in bulk solution in a 1.0 cm quartz cuvette. Spectra were acquired at room temperature on an Agilent™ 8453 UV-vis spectrometer.

Cyclic voltammetric measurements were performed using a CH Instruments CHI-760 workstation controlled by a PC. Unless otherwise noted, a three-electrode setup was used using a platinum coil auxiliary electrode and glassy carbon (GC) disk (3 mm diameter) working electrode. Ag/AgCl and Ag/AgNO₃ reference electrodes were used in aqueous and nonaqueous solutions, respectively. These measurements were performed in aqueous acid (0.5 M H₂SO₄) and nonaqueous solution (acetonitrile and propylene carbonate) using 0.1 M lithium perchlorate and TBAPF₆ as supporting electrolyte.

Four-point probe measurements were performed using a Signatone four-point probe apparatus device attached to a Fluke 87 True RMS multimeter and constant-current source system (CH Instrument, CHI-760 workstation controlled by PC). The probe contacts were spaced 0.040 in. apart.

The electrical conductivity σ (Ω⁻¹ cm⁻¹) was expressed by

σ=In2 i/πd V

where d is the thickness of the films, i is current passed through outer probes, and V is voltage across inner probes (see, for example, Sze, S. M. Semiconductor Devices Physics and Technology, 2^{nd} edition; John Wiley & Sons, Ltd. 2001). Current was applied within the range of 1.0×10⁻⁸-8.0×10⁻⁴ A.

Scanning electron microscopy (SEM) images were collected using a JEOL 5900 IVAN-LV scanning electron microscope. PEDOT films were prepared on the glass slides. No Au/carbon coating was necessary unless otherwise specified.

Atomic force microscopy (AFM) images and thickness of the PEDOT films were obtained using a Dimension™ 3100 from Veeco/Digital Instruments with a Nanoscope VI controller. Topographical Images were performed with tapping mode by using an n+ Si cantilever (Nanosensors PPP-NCH) at a resonance frequency of 300 kHz, and the spring constant was 42 N/m. Images were captured and analyzed using the Nanoscope software (Version 6.1311).

Results and Discussion

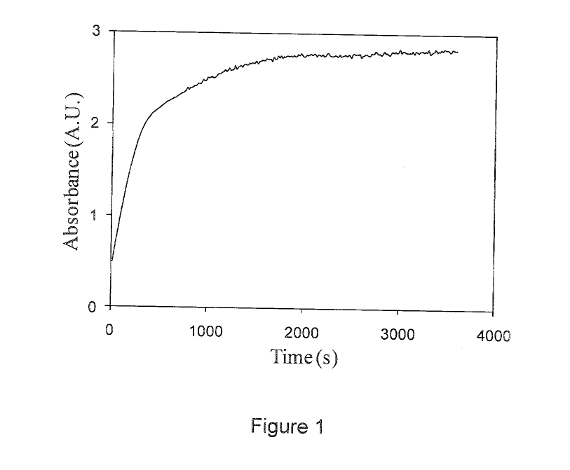

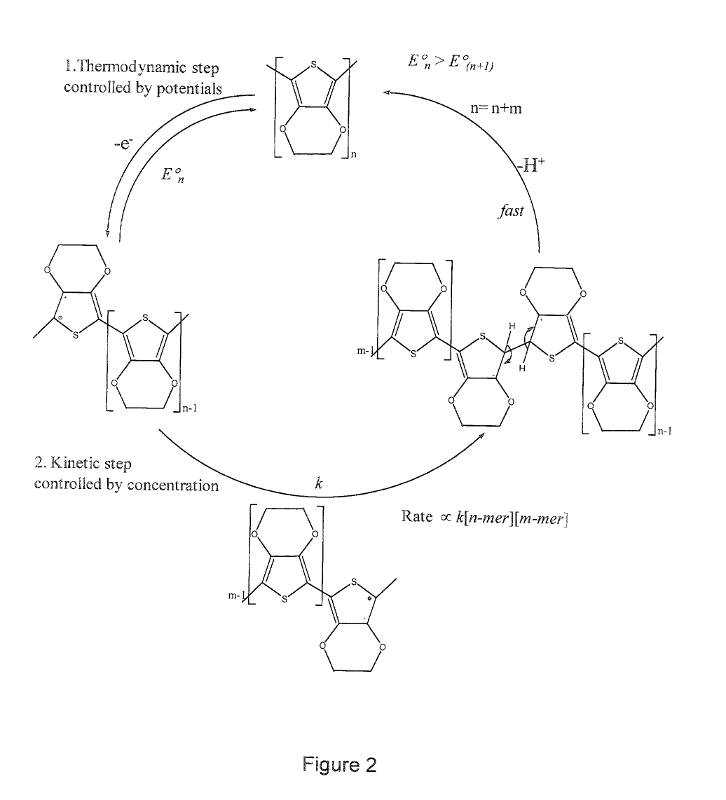

The UV-vis spectrum of oxidized PEDOT has an absorption peak at above 700 nm, which shows the density of the polaronic states (see, for example, Groenendaai, L., Zotti, G., Aubert, P., Waybright, S. M., Reynolds, J. Adv. Mater. 2003, 15, 855 and references therein). The degree of polymerization in solution was monitored by following the evolution of the polaronic band with time as shown in FIG. 1. The spectra were monitored at 700 nm, 800 nm and 900 nm in acetonitrile containing 0.02 M EDOT and 0.03 M PMA (data at 700 nm and 900 nm not shown). Lower concentrations of monomer and oxidant were used in order to reduce the polymerization rate and study the gradual polymer growth. In FIG. 1, the slow initial increase in the polaron band absorbance corresponds to the formation of PEDOT radicals followed by the complete growth of the polymer where absorbance did not vary with time. Without being bound by theory, it is believed that these results show the rapid in situ polymerization of EDOT through solvent evaporation via rate limiting radical coupling reaction as shown in FIG. 2.

Without being bound by theory, it is believed that the mechanism responsible for this process involves the formation of a metastable mixture of oxidant and monomer by selecting an oxidant whose formal potential is close to, but lower than, the oxidation potential of the monomer. In accordance with the Nernst equation, this ensures that the concentration of oxidized monomer (a radical cation) is relatively low, thereby resulting in a relatively slow polymerization rate (a radical coupling reaction). While the solutions are metastable under dilute conditions, concentration (by solvent evaporation) allows the rate-limiting radical coupling reaction to become significantly faster. The first successful completion of the cycle produces dimers that in turn have lower oxidation potentials owing to their increased conjugation length. This condition shifts the balance of the first step to produce relatively more radical cations. The increased concentration of radical cations, resulting from both the more favourable thermodynamics and loss of solvent, causes a further increase in the polymerization rate as the reaction cascades. It is believed that the process relies on a thermodynamic balance of neutral vs. oxidized monomer and concentration-based kinetics. Accordingly, selection of a suitable oxidant for a given monomer and selection of a solvent which evaporates in such a way that the polymerization rate is initially slow are factors for consideration.

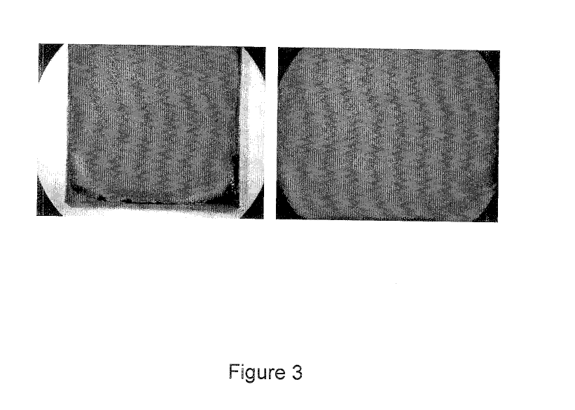

PEDOT/PMA films exhibited smooth, uniform, pinhole free and densely coated morphology at a macroscopic level. Optical images of spin-coated PEDOT/PMA films are shown in FIG. 3. Optical images show that smooth PEDOT/PMA films are produced.

PEDOT/PMA films having different thicknesses were prepared. Thickness of the PEDOT/PMA films was controllable, for example, and without limitation, by adjusting the rotation rate during spin coating. For example, and without limitation, film thicknesses of approximately 100 nm were formed by spinning the substrate at 1000 rpm. Thickness of the PEDOT/PMA films was controllable, for example, and without limitation, by casting multilayer films. For example, and without limitation, film thicknesses of approximately 10 nm up to and including several micrometers were obtained. For example, film thicknesses of approximately 50 nm up to and including 5 microns have been obtained. Reasonably reproducible PEDOT/PMA film thicknesses were obtained.

PEDOT/PMA films exhibited good adhesion to substrates. In terms of a peel test, PEDOT/PMA films displayed good adhesion and resistance to peeling by Scotch™ tape. PEDOT/PMA deposited on a glass substrate was subjected to application of Scotch™ tape which was then removed. The PEDOT/PMA films were not visibly affected by this test, as compared to a similar test applied to commercially available Bayertron™ PEDOT:PSS.

PEDOT/PMA was tested on a glass substrate and found to be resistant to a number of solvents, including acetonitrile, tetrahydrofuran, hexanes, chloroform and toluene. Solvents that were observed to damage the films on the glass substrate in this test include water, N-methylpyrrolidinone, 2-propanol, 1-propanol, ethanol and methanol. When applied to a Kimwipe™, the PEDOT/PMA films proved very resistant to water.

PEDOT/PMA films exhibited good stability on polymer substrates over a range of pH values. PEDOT/PMA film remained adhered to a polymer substrate over a pH range of 0-13 and maintained its conductivity with the application of voltage of 1 volt across the film.

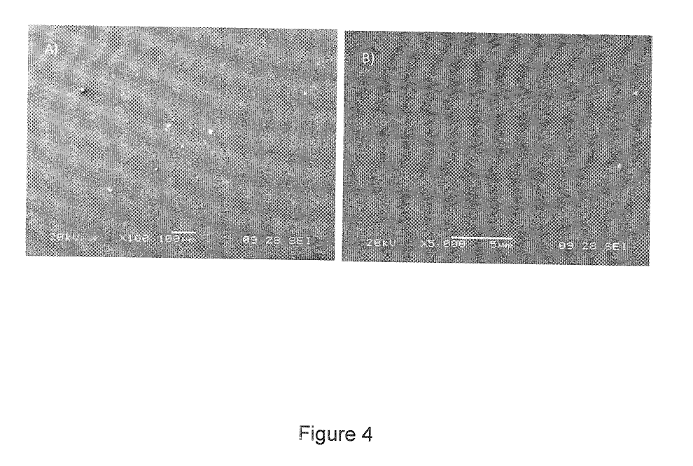

SEM images of the formation of smooth PEDOT film spin-coated onto a glass slide are shown in FIG. 4. SEM images of PEDOT film demonstrate the smooth, uniform, pinhole free and densely coated morphology on the micron scale. The morphology is similar to vapor-phase grown PEDOT/tosylate (see, for example, Winther-Jensen, B., West, K. Macromolecules 2004, 37, 4538) and vapor grown PEDOT/PMA thin films (see, for example, White, A. M., Slade, R. C. T. Electrochimica Acta 2004, 49, 861).

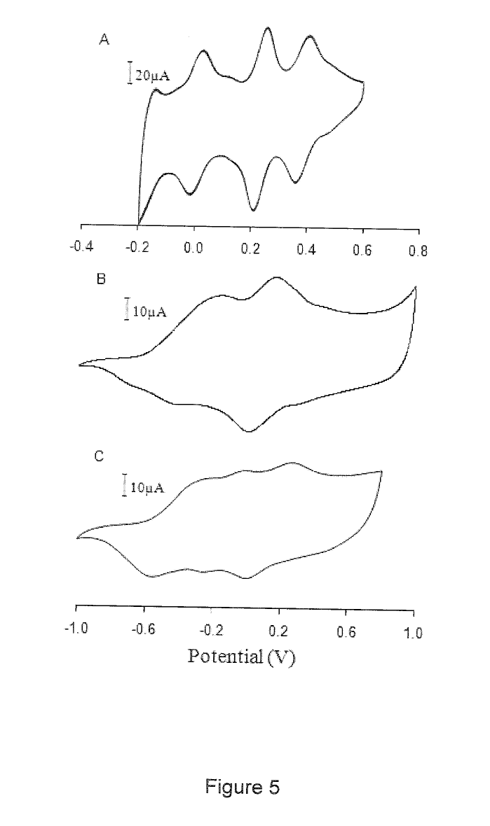

FIG. 5 shows cyclic voltammograms of PEDOT/PMA films in aqueous acid and non-aqueous solutions. In aqueous acid solution, the composite film exhibits facile redox chemistry associated with PMA that is in good electronic communication with the PEDOT (FIG. 5A). The cyclic voltammogram shows three characteristic sets of reduced/oxidized peaks inherent to the PMA (see, for example, Sadakane, M., Steckhan, E. Chem. Rev. 1998, 98, 219). The redox peaks of PEDOT are not visible due to the dominance of PMA peaks (see, for example, Bravo-Grimaldo, E., Hachey, S., Cameron, C. G., Freund, M. S. Macromolecules 2007, 40, 7166; White, A. M., Slade, R. C. T. Electrochimica Acta 2004, 49, 861). The potential window for cyclic voltammograms in aqueous acid solution was limited from −0.2 to 0.6 V vs. Ag/AgCl, since more-negative potentials lead to the irreversible decomposition of PMA under these conditions (see, for example, Wang, B., Dong, S. J. Electroanal. Chem. 1992, 245, 328). In contrast, in non-aqueous solution, the typical redox behavior associated with PMA is not observed (FIGS. 5B and 5C). Also, the peaks associated with PMA do not reappear when returned to aqueous acid solution. These results suggest that either PMA leaches out of the polymer or does not remain in the form of a Keggin structure within the polymer (see, for example, Bravo-Grimaldo, E., Hachey, S., Cameron, C. G., Freund, M. S. Macromolecules 2007, 40, 7166; Suppes, G. M., Deore, B. A., Freund, M. S. Langmuir 2008, 24, 1064). The cyclic voltammogram in acetonitrile with 0.1 M TBAPF₆ (FIG. 5B) exhibits two sets of redox peaks (Eₚₐ₁ 0.16, E_{pc1} −0.42, Eₚₐ₂ 0.17 and E_{pc2} 0.003 V) vs. Ag/Ag⁺. These redox peaks are attributed to the facile conversion of polymer from the neutral to the polaronic state and from polaron to the bipolaron metallic state (see, for example, Chen, X. W., Inganas, O. J. Phys. Chem. 1996, 100, 15202; Snook, G. A. Peng, C. Fray, D. J. Chen, G. Z. Electrochem. Commun. 2007, 9, 83). However, the redox behavior in propylene carbonate with LiClO₄ shows an additional redox peak as shown in FIG. 5C. These results suggest that the intermediate redox species observed in propylene carbonate is not stable in acetonitrile.

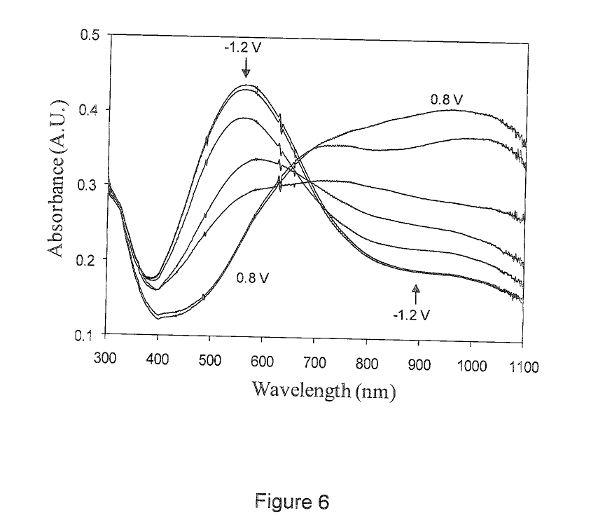

Using the above CV experiments as a means of determining the correct potential ranges for switching and evaluating the stability of the electroactivity of the PEDOT/PMA film, in situ spectroelectrochemical experiments were conducted as shown in FIG. 6. The spectroelectrochemistry in non-aqueous solution shows that the PEDOT film allows a very reproducible transition between reduced and oxidized states through an isosbestic point in the potential range of −1.0 to 0.8 V. The neutral (reduced) film shows a strong absorption in the visible region at ˜560 nm due to the π-π* electronic transition (see, for example, Groenendaal, L., Zotti, G., Aubert, P., Waybright, S. M., Reynolds, J. Adv. Mater. 2003, 15, 855 and references therein) and appears deep blue in color. Upon oxidation, π-π* absorbance at 560 nm decreases and gives way to charge carrier bands at 800 nm and 1050 nm (see, for example, Groenendaal, L., Zotti, G., Aubert, P., Waybright, S. M., Reynolds, J. Adv. Mater. 2003, 15, 855 and references therein). The oxidized (doped) film appears light blue and highly transparent.

Table 1 shows the conductivity of PEDOT/PMA films prepared in acetonitrile at different monomer to oxidant ratios. The final concentrations of EDOT and PMA in the mixture were varied in order to optimize the conductivity. A conductivity of around 1.93 S/cm was obtained at monomer to oxidant concentration of 0,2 M/0.3 M. PEDOT/PMA films, including PEDOT/PMA films redoped with an oxidizing agent, showed conductivities in a range of 0.03 to 5 S/cm.

By redoping the film with oxidizing agent, iron toluenesulfonate, conductivity can be enhanced 2-3 times. The conductivities measured for iron (III) paratoluenesulfonate-doped PEDOT/PMA ranged from 2.01 S/cm for the original 0.4 M/0.1 M PEDOT/PMA formulation to 3.38 S/cm for the 0.2 M/0.3 M formulation.

The conductivity of PEDOT films obtained here is similar to those reported in the literature for PEDOT/PSS films (see, for example, Jonas, F., Morrison, J. T. Synth. Met. 1997, 85, 1397; Jonas, F., Heywang, G. Electrochim. Acta 1994, 39, 1345) and pressed-pellet of powders (see, for example, Lefebvre, M., Qi, Z., Rana, D., Pickup, P. G. Chem. Mater. 1999, 11, 262).

TABLE 1
Conductivity of PEDOT/PMA films prepared in
acetonitrile at different monomer to oxidant ratios.

| Concentration (EDOT/PMA (M)) | Conductivity (S/cm) |
|---|---|
| 0.1/0.1 | 0.38 |
| 0.15/0.1 | 0.35 |
| 0.2/0.1 | 0.10 |
| 0.2/0.2 | 0.90 |
| 0.2/0.3 | 1.93 |
| 0.3/0.2 | 0.69 |
| 0.4/0.1 | 0.04 |
| 0.4/0.3 | 0.57 |

Conducting PEDOT films with excellent quality can be prepared by in situ polymerization utilizing metastable monomer/oxidant mixtures. The film shows well behaved redox chemistry, spectroelectrochemical switching behavior and high conductivity similar to PEDOT films prepared using conventional chemical and electrochemical methods. The conductivity of the PEDOT films can be enhanced by redoping with different dopants in different solvents. PEDOT may be used, for example, and without limitation, for antistatic coatings on different materials.

Conclusions

Approaches for the synthesis of PEDOT using an easily processable mixture of monomer EDOT and oxidant phosphomolybdic acid (PMA) that is metastable in solvent acetonitrile, yet rapidly polymerizes upon solvent evaporation have been demonstrated. The polymerization was observed to be dependent on the thermodynamic balance of neutral vs. oxidized monomer and concentration-dependent radical coupling rate. The conductivity of PEDOT/PMA films has been optimized by varying monomer to oxidant ratios. The films have been characterized using spectroscopic, electrochemical and microscopic techniques.

Embodiments include isomers such as geometrical isomers, optical isomers based on asymmetric carbon, stereoisomers and tautomers and is not limited by the description of the formula illustrated for the sake of convenience.

Although the foregoing embodiments have been described in some detail by way of illustration and example, and with regard to one or more embodiments, for the purposes of clarity of understanding, it is readily apparent to those of ordinary skill in the art in light of the teachings of the embodiments that certain changes, variations and modifications may be made thereto without departing from the spirit or scope of the embodiments as described in the appended claims.

It must be noted that as used in the specification and the appended claims, the singular forms of “a”, “an” and “the” include plural reference unless the context clearly indicates otherwise.

Unless defined otherwise all technical and scientific terms used herein have the same meaning as commonly understood to one of ordinary skill in the art to which the embodiments belong.

All publications, patents and patent applications cited in this specification are incorporated herein by reference as if each individual publication, patent or patent application were specifically and individually indicated to be incorporated by reference. The citation of any publication, patent or patent application in this specification is not an admission that the publication, patent or patent application is prior art.

1. A method of preparing poly(3,4-ethylenedioxythiophene) (PEDOT), the method comprising mixing 3,4-ethylenedioxythiophene (EDOT) and an oxidant in a solvent, and removing the solvent to produce PEDOT.

2. The method according to claim 1, wherein the solvent is removed by evaporation.

3. The method according to claim 1, wherein the oxidant is phosphomolybdic acid.

4. The method according to claim 1, wherein the solvent is acetonitrile.

5. The method according to claim 1, wherein PEDOT is formed by spin coating.

6. The method according to claim 1, which further comprises doping the PEDOT with an oxidizing agent.

7. The method according to claim 6, wherein the oxidizing agent for doping the PEDOT is iron (III) paratoluenesulfonate.

8. Poly(3,4-ethylenedioxythiophene) (PEDOT) produced by a method according to claim 1.

9. PEDOT according to claim 8, which is smooth and pinhole-free.

10. PEDOT according to claim 8, which has a conductivity in a range of 0.03 to 5 S/cm.

11. PEDOT according to claim 8, which is a film having a film thickness of 50 nm up to and including 5 microns.
